(19) United States
(12) Patent Application Publication
(10) Pub. No.: US 2016/0372100 A1
(43) Pub. Date: Dec. 22, 2016

(54) SOUND ATTENUATING PANEL

(71) Applicant: KONINKLIJKE PHILIPS N.V., Eindhoven (NL)

(72) Inventors: JONATHAN DAVID MASON, WAALRE (NL); BERENT WILLEM MEERBEEK, EINDHOVEN (NL); ANTHONIE HENDRIK BERGMAN, NUENEN (NL); KARIN KLABUNDE, BOCHUM (DE); BAHAA EDDINE SARROUKH, HELMOND (NL)

(21) Appl. No.: 14/901,488

(22) PCT Filed: Jul. 1, 2014
(86) PCT No.: PCT/EP2014/063908

§ 371 Date: Dec. 28, 2015

(30) Foreign Application Priority Data
Jul. 2, 2013 (EP) 13174596.0

(51) Int. Cl. G10K 11/172; G10K 11/00; E04B 1/82; G10K 11/168

(52) U.S. Cl. CPC G10K 11/172; G10K 11/168; G10K 11/004; E04B 1/8209

(57) ABSTRACT

The invention provides a sound attenuating panel (100) with controllable sound attenuation properties, the sound attenuating panel (100) comprising (a) a sound attenuating unit (200) with cavities (212) with variable dimensions and (b) an infrastructure (300) for controlling the dimensions of the cavities (212) in the sound attenuating unit (200). The sound attenuating unit comprises sound attenuating material with controllable sound attenuating properties, but may also have wave guiding properties, thereby allowing to combine in the sound attenuating unit 200 both sound attenuating properties and optical properties.

### FIELD OF THE INVENTION

The invention relates to a sound attenuating panel, to a system comprising such panel as well as to the use of such panel (and system).

### BACKGROUND OF THE INVENTION

Acoustic panels, such as for use in work spaces, are known in the art. An example of an acoustic panel can e.g. be found in WO 2013/085935. This document describes a sound absorbing luminaire providing lighting for an interior space environment and managing the acoustics within the environment. The luminaire includes a frame holding an acoustic film and a lighting element, forming a resonant cavity between them. The acoustic film is used for absorbing sound within the resonant cavity, and the lighting element provides light from a light source, such as LEDs, through the acoustic film. An optical film can be mounted in the frame between the acoustic film and the lighting element for providing a desired distribution of light.

### SUMMARY OF THE INVENTION

The office environment is changing. New type of working environment, sometimes referred to as ‘workplace innovation”, can be observed. There is a clear trend in offices towards different areas for special purposes like e.g. meetings, telephone calls or concentrated work.

There are fewer single-person offices and fixed personal workplaces. Rather, people choose on a daily/hourly basis the type of work place that is appropriate for their current task. The driving forces behind this development are demands for higher flexibility with respect to collaborative ways of working (e.g. flexibly grouping people into teams) and for more efficient use of office space in general. Within these new more open, adaptive-office environments, appropriate lighting, noise, acoustics and privacy concerns play a much more important role.

A big disadvantage of existing desk divider solutions is that they are static and do not adapt to changes in the open office environment. For example, people might change their type of activity several times during the day from concentrated work to communicating with colleagues. A desk divider that could adapt its functioning to better suit the needs of the office worker is desirable to enhance satisfaction with the work environment and possibly even productivity.

Hence, it is an aspect of the invention to provide an alternative sound attenuating panel, for instance for use as room divider or desk divider, which preferably further at least partly obviates one or more of above-described drawbacks. It is also an aspect of the invention to provide an alternative system comprising such sound attenuating panel, which preferably further at least partly obviates one or more of above-described drawbacks. This invention describes amongst others a desk/room divider that combines visual and acoustic adaptability to better suit demands of modern office environments, in essence this invention adds ‘visual and acoustic dimming’ to desk/room dividers. Amongst others, the invention describes a (vertical) screen such as a desk divider or room divider that can switch from an optically (nearly) transparent surface to a light-emitting (nearly) opaque-like surface and methods to control the light output. This is in conjunction with an adaptive sound absorption system that can reduce the sound level in an area or ‘open’ up to allow the sound to pass through to facilitate conversation between office workers. The invention also describes a (vertical) screen, such as a desk divider or room divider, including an adaptive sound absorption system that can reduce the sound level in an area or ‘open’ up to allow the sound to pass through to facilitate conversation between office workers optionally in conjunction with the functionality of switchability from an optically (nearly) transparent surface to a light-emitting (nearly) opaque-like surface (and methods to control the light output).

Hence, in a first aspect, the invention provides a sound attenuating panel (herein also indicted as “panel” or “acoustic panel”) with controllable sound attenuation properties and controllable light transparency, the sound attenuating panel comprising (a) a sound attenuating unit (herein also indicated as “unit”) with cavities with variable dimensions, (b) a transparent material, (c) an actuator for controlling the dimensions of the cavities in the sound attenuating unit, and a light source for controlling the transparency of the sound attenuating panel. Yet, in a further aspect the invention provides a system comprising such sound attenuating panel, and one or more of a control unit and a sensor, wherein the control unit is configured to control a device as function of a sensor signal from the sensor, wherein the device is selected from the group consisting of the sound attenuating panel and another device. In specific embodiment, the sound attenuating panel comprises a transparent part, of which the transparency, or perceived transparency can be controlled as well, especially in combination with the control of the attenuation properties.

With the sound attenuating panel and system as described herein the acoustic environment, in e.g. open areas, can be improved. Further, optionally also visual privacy, for for instance people working in an open space, may be improved (see also below). Advantageously, the attenuating properties may be controlled, e.g. by the user of the panel, or via a remote system. Optionally, via an intuitive way both visual and sound privacy may be controlled with the panel. For instance, now a desk divider can be provided that could adapt its functioning to better suit the needs of the office worker which is desirable to enhance satisfaction with the work environment and possibly even productivity.

Especially, efficient sound absorbing material may be porous. This means that they consist of cavities into which the sound waves can pass and dissipate their sound energy as vibrations in the material and is thus released as heat. These types of material therefore reflect very little of the sound that comes in contact with them. Especially, different types of pores (within the same material) can be useful. Closed pores are like bubbles in a material and while helping to reduce the mass of the material they may be less efficient at absorbing sound. Blind pores are like long caves in a rock face. Sound waves can pass into the blind pore and may be absorbed. A pore can also be tunnel like where the depth is the same as the thickness of the material, thus the sound could potentially pass through the material entirely. A general definition of a porous material is that the pores (holes, caves or tunnels) must be deeper than they are wide.

Sound absorbing porous materials may be based on a fibrous structure (e.g. textile). Other types may include cellular (e.g. foamed materials) or granular (e.g. sands, concretes). An advantage of the fibrous textiles is that they can be stretched and thus their physical form can be altered; this in turn will alter their sound absorbing properties. Assuming a fibrous material, like textile, when pulled in one or more directions the space between the fibres increases and the sound absorption ability may reduce. The same may be true for a (cellular) material with holes (tunnels) cut into it. When pulled in one direction the holes will stretch and this will allow more sound to pass through. Hence, in a specific embodiment, the sound attenuating unit comprises a material with cavities (or voids) that are variable in one or more of width and diameter, and the infrastructure is configured to controlling the one or more of width and diameter of the cavities in the sound attenuating unit. For instance, the sound attenuating unit may comprise textile or a polymer with controllable acoustic properties

As defined above, the invention provides a sound attenuating panel. The panel may for instance be used as room divider or desk divider. Optionally, the panel may also be used as wall panel or ceiling panel. The panel may in principle have any dimension, like e.g. length and height each independently selected from the range of 0.2-50 m, like 0.4-15 m, though smaller or larger dimensions may also be possible. Further, also modular systems may be used which function as one single sound attenuating panel, or which consist of a plurality of sound attenuating panels. Hence, the term “panel” may refer to a plurality of panels. Likewise, the term “sound attenuating unit” may also relate to a plurality of sound attenuating units. In an embodiment, a panel may comprise a plurality of sound attenuating units. Hence, in operation the panel may be arranged horizontal, vertical or any other arrangement. The panel may be flat, may be curved, etc.

The width of the panel may in embodiments e.g. be in the range of 1-200 mm, such as 5-100 mm. In general, the length and height is substantially larger than the width. The panel is not necessarily rectangular (or square), but may also have other shapes. The panel may in embodiments especially have a height selected from the range of 140-190 cm, especially 150-185 cm, or selected from the range of 70-125 cm, especially 80-120 cm. The former height may especially be suitable for room dividers (office dividers); the latter height may especially be suitable for desk dividers. However, other dimensions may also be possible. For instance, the width may also be larger than 200 mm. Optionally, also the height and/or length may be larger or smaller.

The term “sound attenuating panel” especially relates to a panel that is able to attenuate or reduce sound. Attenuation of sound can for instance be obtained by e.g. absorbing and/or blocking sound waves that would otherwise propagate from one place, such as one desk to another place, such as another desk. In a specific embodiment, the panel is configured to absorb and/or diffuse sound. Therefore, in an embodiment the panel material (or “sound reducing material” or “attenuating unit material”), i.e. the material comprised by the sound attenuating unit, may comprise a sound absorbing material and/or a sound diffusing material. Hence, the term “attenuating” may include an absolute reduction of the sound, or a blocking, or a reflection, of (part of the sound), such that beyond the panel, the sound is attenuated. The term “panel material” or “sound reducing material” may also relate to a plurality of different materials.

The sound attenuating panel comprises a sound attenuating unit. Especially the unit is the part that may give the panel its sound attenuating property. At least this unit comprises panel material or sound attenuating material. In addition to the sound attenuating unit, the panel also comprises an infrastructure for controlling the sound attenuation properties. This infrastructure may for instance comprise one or more actuators, a control unit, a user interface, etc. In general, this infrastructure will be integrated in the panel. The infrastructure will in general comprise electronic elements, like an electronic actuator for applying a force to the attenuating unit. This may be a pulling force or a pressing force, etc. Herein, the term “actuator” may also relate to a plurality of actuators. Other options are also possible, see also below. Further, other elements may be present in the panel as well, see also below. Especially, the infrastructure comprises a device for applying a force to at least part of the sound attenuating unit. Such force may be an electromagnetic force, a friction force, a tension force, an elastic force, etc. A combination of two or more forces may also be applied.

The sound attenuating properties may be controlled by the fact that the sound attenuating unit comprises cavities with variable dimensions and or shape, for example dimensions like width, diameter, length, but also shape aspects of the cavities like curvature, tapering and orientation (length direction) with respect to the main surfaces of the sound attenuating panels. Hence, the panel material comprised by the sound attenuating unit comprises cavities with variable dimensions. By varying these dimensions, also the sound attenuating properties may be varied. In general, the panel can be brought in a first (acoustic) state wherein the sound attenuating properties are maximum (most sound reduction/absorption) and in a second (acoustic) state wherein the attenuating properties are minimum. Especially, the panel, more especially the sound attenuating unit and the infrastructure may, be configured to provide a range of configurations between the first state and the second state.

Control of the panel may be done via a user interface. This user interface may be integrated in the panel or may be arranged remote. For instance, the user interface may be also be provided as application on a computer, laptop, a cell phone, a personal digital assistant (PDA), a Smartphone, a tablet, an ultra book, and a device integrated into personal wearing. For instance, via a graphical user interface the panel may be controlled. However, control of the panel may also be executed in other ways. For instance, a control unit may control the panel, for instance based on one or more of predetermined settings, sensor signals, and remote control commands. For instance, predetermined settings may relate to time dependent settings. Based on empirical and/or historical data, the panel may be set in the desired attenuation state. However, based on a sensor signal (see also below), like a sound level sensor, the panel may also be set to a specific attenuation state.

In a specific embodiment, the sound attenuating unit comprises a fibrous material (as panel material or sound attenuating material) with spaces between adjacent fibers. In such embodiment, the infrastructure for controlling the dimensions of the cavities may especially comprise a device for applying a force to the fibrous material. In an embodiment, the sound attenuation unit comprises a plurality of (adjacent) layers of fibrous material. In a specific embodiment, two or more of these may be controlled individually. The infrastructure may, not only in this embodiment but also in other embodiments, also be configured to provide different forces, such as forces in different directions, to the panel material, in this embodiment the fibrous material. An example of a fibrous material is especially a textile.

In another specific embodiment, the sound attenuating unit comprises a deformable porous material (as panel material or sound attenuating material) with pores. In such embodiment, the infrastructure for controlling the dimensions of the cavities may (also) especially comprise a device for applying a force to the deformable porous material. An example of porous material is especially a polymer foam or a silicone membrane or a 3D textile, etc.

In another specific embodiment, the deformable porous material comprises a stimuli-responsive polymer. Such stimuli-responsive polymer may e.g. especially be able to contract or extend under influence of a potential difference. Such polymers are also known as “smart” polymers. They are considered to be high-performance polymers that change according to the environment they are in or according to stimuli provided to the polymer. Such materials can be sensitive to a number of factors, such as temperature, humidity, pH, the intensity of light or an electrical or magnetic field and can respond in various ways, like altering transparency and/or (also) sound attenuating properties. Due to an action of the infrastructure, such as applying an electrical potential to the polymers, the polymers may form open or closed structures, and thereby provide cavities or (partly) close cavities. In an embodiment, the infrastructure for controlling the dimensions of the cavities (or pores) may (also) especially comprise a device comprising a source of electrical energy.

In another specific embodiment, the sound attenuating unit comprises two or more panels, arranged parallel and adjacent to each other, each panel comprising holes, wherein the two or more panels are arrangeable in a set of configurations comprising at least a first configuration and a second configuration with different sound attenuations. For instance one may imagine a configuration wherein the holes (of both panels) substantially overlap, leading to low(er) sound attenuation properties, and a configuration wherein the holes (of both panels) do not substantially overlap, leading to stronger sound attenuation properties. In such embodiment, the infrastructure for controlling the dimensions of the cavities may especially comprise a device for arranging the two or more panels in at least two different (sound attenuating level) configurations. In a first configuration, the holes may be through holes, and in a second configuration the holes are partly through holes are blocked. Hence, in a first configuration, the length of the (through) holes is the length of holes in the two or more panels, whereas in another configuration, especially in a block configuration, this length is different, e.g. only of a hole in one of the plates. In the second configuration, the holes can also be seen to be distorted relative to a configuration wherein a though hole is available through the two or more plates. Hence, the cavities (i.e. here a through hole of a configuration wherein there is a through hole through two or more plates) have variable dimensions. In such sound attenuating unit comprising two or more panels, with each panel comprising holes, the panes are especially arranged parallel. The distance between the panels may be very small, such as 0.1-5 mm.

Hence, the panel comprises cavities with variable dimension. These cavities may also be indicated as voids, such as pores in a foam, channels in a material, spaces between fibers, etc.

In an embodiment, the sound attenuating unit comprises a light transmissive unit part comprising a material that is transmissive for visible light, such as being translucent or transparent. Especially, the sound attenuating unit comprises (thus) a transparent unit part comprising a material that is transparent for visible light (herein also indicated as “transparent material”). Especially this transparent unit part is configured to allow transmission of light from one face to another face of the panel. Hence, one may be able to look to at least part of the panel (by looking through the (light) transparent unit part comprising the material that is transparent for visible light). Herein, light especially relates to visible light. The transparent unit part is thus especially transparent for visible light, and may in operation—be used to look through the sound attenuating panel (however, see also below).

Hence, in a specific embodiment, the light source is configured to provide light into the transmissive unit part, especially a transparent unit part, wherein the (transparent) unit part has light guiding properties and wherein the transparent unit part is configured to allow transmission of visible light from a first face of the sound attenuating panel to a second face, and wherein the (transparent) unit part and light source are configured to be able to provide light escaping to at least one of the faces of the sound attenuating panel. Especially, the (transparent) unit part and light source are configured to be able to provide light escaping to both faces of the sound attenuating panel. As will be indicated below, in specific embodiment the sound attenuating unit material or panel material comprises such material that is transmissive, especially transparent, for visible light. Hence, in an embodiment the panel material is material that is transparent for visible light, or one or more parts of the sound attenuating unit comprises such material that is transparent for visible light (i.e. part of the attenuating unit comprises the transparent unit part). Hence, in embodiments the sound attenuating unit comprises the material that is transparent for visible light. The transparent unit part may especially comprise outcoupling structures, at an exit surface, and/or embedded in the material that is transparent for visible light. Herein, the material that is transparent for visible light is also indicated as transparent material. This light can be used to assist a person in doing activities and/or in generating a specific atmosphere, and/or can be used to create privacy. When the light of the light source is coupled into the unit part, light will be coupled out from the transparent unit part. In this way, the perceived transparency is reduced, as a spectator will now not see, or see less, objects behind the transparent unit part, but will see the light coupled out (in the direction of (amongst others) the spectator. The fact that a spectator will especially see the light and not an object behind the transparent unit, while the transparency may not really be affected, is indicated as (reduction of) perceived transparency.

In a specific aspect, the infrastructure may include a bi-metal device that is configured to change shape as a function of the temperature, and wherein the bi-metal device is configured to control the sound attenuation properties as function of heat from a light source, especially one or more LEDs, that are in embodiments incorporated in the panel. When the LEDs (or other light sources) are switched on, indicative of e.g. a privacy mode, the bi-metal may e.g. close cavities in the panel to block and absorb the sound from passing through.

In a specific embodiment, the light source comprises a solid state LED light source (such as a LED or laser diode). The term “light source” may also relate to a plurality of light sources, such as 2-20 (solid state) LED light sources. However, more light sources may of course also be applied. Hence, the term LED may also refer to a plurality of LEDs. The terms “visible”, “visible light” or “visible emission” refer to light having a wavelength in the range of about 380-750 nm.

The light source may especially be configured to generate white light. The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL.

Above, the principle of controlling the sound attenuating properties is described. Amongst others, this above principle is applied in this invention, optional also in combination with lighting properties, as for instance the acoustic material may also have light guiding properties (wave guiding properties). Hence, the principle of controlling acoustic properties by modulating cavities (like spaces, holes, pores, etc.) in a material may also be applied to a light divider concept to improve its acoustic properties since it is currently made from a hard polymer or glass like material into which light is coupled. Once the light has been coupled into the material the users will find it harder to see through the divider, thus enhancing the feeling of privacy. When the user turns on the light to increase the feeling of privacy, the absorption of sound should also increase since it is most likely that the user desires to work in a quiet context. At this point, the sound absorbing material/screens that may be located in the area or on the light dividing screens could change shape to absorb more of the sound. When the user turns off the light, the transparent part of the panel may also be perceived as transparent (as the light is not changing the perception anymore) and so the user or other people can see through the transparent part. At both faces of the acoustic panel, they can see each other and perhaps once they begin to talk. The sound absorbing material may be flexed to open up the fibers or openings to enable the passage of sound and ease conversation.

Hence, in a further aspect the invention also provides the use of a sound attenuating panel as described herein, wherein the sound attenuating panel comprises a transparent unit part comprising a material that is transparent for visible light, wherein the transparent unit part is in a first (optical) state configured to allow transmission of visible light from one or more of (i) a first face to a second face, (ii) the second face to the first face, and (iii) both from the first face to the second face and from the second face to the first face of the sound attenuating panel, wherein (a) the acoustic properties are controllable via an actuator fro improving acoustics in a space, and (b) one or more of (b) the transmission of visible light through the transparent unit part and (b2) a perceived transmission through the transparent unit part is controllable via a light source providing light into the transparent unit part for controlling visual privacy in said space.

The phrase “first state configured to allow transmission of visible light from one or more of (i) a first face to a second face, (ii) the second face to the first face, and (iii) both from the first face to the second face and from the second face to the first face” indicates that there is at least a state wherein a spectator can view through the panel from a first face to a second face, or from a second face to a first face (thus semi transparent systems are herein also included), or spectators at both faces can see each other through the panel. This phrase also includes embodiments wherein the transparent unit part is configurable in other (optical) states. For instance, the invention may also include embodiments wherein the transparent unit part is configurable in a fully transparent state and in a semi-transparent state. Hence, with the present invention it is also possible to intuitively control the sound and privacy properties. Either set by the user or via other options, when there is a desire to concentrate on an action, light may be switched on, which may assist in performing the action, and at the same time this improves privacy. Further, also the sound attenuating properties may be increased, also enhancing privacy and the ability to concentrate on the action. A control unit may control the light source and the sound attenuating properties, which may in specific embodiments especially be coupled, in the sense that e.g. transparency of the light transmissive material is related to the sound attenuating properties of the (same) material.

In a further embodiment, the sound attenuating panel further comprises one or more of a sensor and a control unit, especially both such sensor and control unit. The sensor may be any sensor, such as selected from one or more of environmental condition sensors, such as thermally sensitive (e.g., temperature, infrared) sensors, humidity sensors, motion sensors, photo sensors/light sensors (e.g., photodiodes, sensors that are sensitive to one or more particular spectra of electromagnetic radiation such as spectro radiometers or spectro photometers, etc.), various types of cameras, sound or vibration sensors or other pressure/force transducers (e.g., microphones, piezoelectric devices), and the like. Especially, the sensor comprises one or more of a microphone and a sound pressure sensor. The term “sensor” may also relate to a plurality of sensors.

Further, especially the control unit is configured to control a device as function of a sensor signal of the sensor, wherein the device is selected from the group consisting of the sound attenuating unit, a light source and another device. The control unit may for instance control based on predetermined settings, by which a panel may become a smart or intelligent panel. For instance, it may be sensed that a person is working or making a telephone call, which may lead to a corresponding privacy and/or sound attenuating setting. When however people are communicating with each other but located at both faces of the panel, the privacy and/or attenuating settings may be adapted to facilitate communication.

In a further aspect, the invention also provides a system comprising the sound attenuating panel, such as described herein, a control unit, and a sensor, wherein the control unit is configured to control a device as function of a sensor signal from the sensor, wherein the device is selected from the group consisting of the sound attenuating panel and another device. Again, as indicated above especially the sensor comprises one or more of a microphone and a sound pressure sensor. Hence, in a further specific embodiment, the sensor comprises a sound sensor configured to measure sound in a space wherein the sound attenuating panel is applied, configured to provide a corresponding sound sensor signal, wherein the sound attenuation properties of the sound attenuating panel and optionally properties of the optional other device are controlled as function of the sound sensor signal. Such system may comprise a plurality of panels and one or more control units. One control unit may control all panels. However, in embodiments, each panel comprises its own control unit (whether or not controlled remote). In a specific embodiment, each panel comprises a control unit, but the system also comprises a main control unit, higher in rank than the local control units of each panel.

In a further aspect, the invention provides a system comprising a sound attenuating panel, a control unit, and a sound sensor, wherein the sound sensor is configured to measure sound in a space wherein the sound attenuating panel is applied and is configured to provide a corresponding sound sensor signal, wherein the control unit is configured to control a device as function of the sound sensor signal, wherein the device is selected from the group consisting of the sound attenuating panel and another device.

The sound attenuating panel will in general be arranged in a space. The space may for instance be (part of) a hospitality area, such as a restaurant, a hotel, a clinic, or a hospital, an office, a department store, a warehouse, a cinema, a church, a theatre, a library, etc. The sound attenuating panel may divide a space in two or more subspaces, such as (working) cubicles or private parts within a single hospital or nursery home room. The invention may however also be applied in automotive or in (outdoor) building applications, etc. For instance, the panel may also be used in applications wherein aesthetics and (outdoor) sound reduction may be of interest, such as in applications in a city to reduce sound. The lighting function may also be of use, as during the night both light might be desired and an increased sound attenuation may be desired.

In an embodiment, the envisioned material for use as transparent material may have a tiny amount of a bulk diffusing material. This means that the light that is diffused, or in in other words, the light that will be redirect towards the users or in yet another wording, the visible light, is a function of the amount of this scattering material. When the bulk material contains a lot, the light that is inserted in the material is diffused rapidly and the plate will light up a lot (and close to the source). It also means that further away from the source the major amount of the light is already used and the panel starts to become dark (or in this application “transparent”) again. This means that given a certain distance between the light source (e.g the length of the plate or half the length of the plates if light sources are placed on both faces) determines the preferred amount of diffusing material. Hence, the amount of diffusing material incorporated in the transparent material may be inhomogenous (and depend upon the distance from a light source), such as to promote a homogeneous outcoupling of light from the transparent unit part. The thickness of the plate also plays a role and the desired homogeneity should also be taken into account. The amount of diffusing material may also be related to the desired efficiency, as with lower amount of diffsuing material, efficiency may be lower, but transparency may be better. Applying very little diffusing material in the bulk may imply that one you hardly extracts light and (but) the homogeneity will be very good as actually most of the light will reach the other face of the plate and might be lost (or partly reflected by mirror pieces in between LEDs). The small amount of extraction can be compensated by just having a very high input of light. Another approach may be to increase the length of the plate material without the compromises, is to have a gradient in the amount of diffusing material. Another option is to have a wedged plate combined with a wedge of pure PMMA stick together to make a constant thickness plate again. This plate will be optical comparable to a plate with a gradient in the amount of diffuse material. Another option is to use multiple plates e.g. a normal PMMA plate with no diffusing particles to start with and continue at some point with a plate with diffuse material. This combi-plate can be sandwiched with another (set of) plate(s). Yet another embodiment could be a transparent plate with local areas with diffuse material. This has the advantage of little light loss across the plate and still light patches all over. This might actual work better than homogeneous light as one may tend to focus on the plate (and not on the person across).

In the in the viewing direction the transparent plate is thin (for instance 1-20 mm, such as 4 to 12 mm) and in the direction the LED light is inserted the thickness/length may be very large (for instance 400-2000 mm). This makes the plate ‘diffuse’ for the inserted light, a lot of change to hit a diffusing particle. On the other face, it means that for the viewer the plate remains very transparent in all situations. However, if it starts to emit light there will be a competition between the light from the plate and from say the reflection of the person setting on the other face of the screen.

The perception or visibility of that person may thus strongly depend on one's focus. An other important aspect is the amount of light coming from the screen in comparison to the amount of reflected light of that person. So to optimize privacy, one can increase the amount of light coming from the screen but also decrease the amount of light on the other person. Hence, different light sources may be controlled as function of a (sound) sensor signal.

In an embodiment, when the ‘sensors’ detect a difference in desired privacy, not only the amount of light from the panel may be adjusted (in conjunction with the sound absorbing properties), but also the amount of illumination of the persons across the divider.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”.

For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

DE102006030907A1 discloses a sound attenuating panel with controllable sound attenuating properties in which dimensions of cavities are varied by means of control of sub-atmospheric pressure in the cavities.

DE822170C discloses a sound attenuating panel comprising two plates each provided with through holes, the overlap of these holes between the two plates can vary to control the dimension of the holes and thus change the acoustic properties of the panel.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict some general principles;

FIGS. 2a-2f schematically depict some embodiment of the sound attenuating panel;

FIGS. 3a-3b schematically depict a further embodiment;

FIGS. 4a-4c schematically depict yet further embodiments; and

FIGS. 5a-5b schematically depict an embodiment of the system comprising such sound attenuating panel(s).

The drawings are not necessarily on scale.

### DETAILED DESCRIPTION OF THE EMBODIMENTS

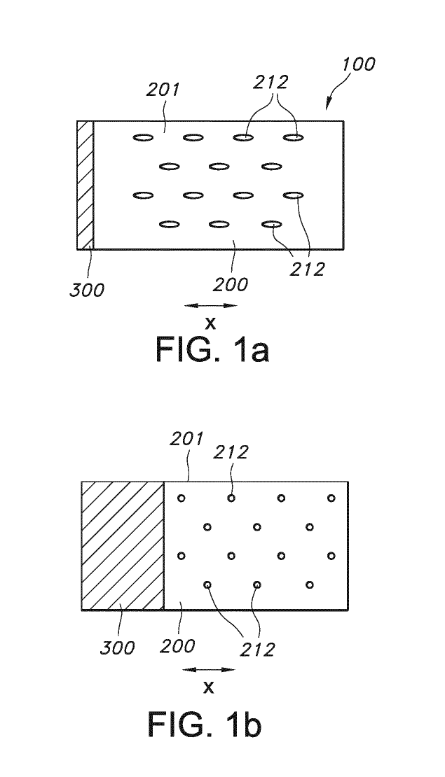

FIGS. 1a-1b very schematically depict an embodiment of the sound attenuating panel. The panel is indicated with reference 100. The sound attenuating panel 100 comprises (a) a sound attenuating unit 200 with cavities 212 with variable dimensions and (b) an infrastructure 300 for controlling the dimensions of the cavities 212 in the sound attenuating unit 200. The infrastructure can e.g. comprise an actuator configured to stretch (and/) or press the panel material, indicated with reference 201. FIG. 1a schematically shows a stretched (or relaxed) configuration and FIG. 1b may for instance show a relaxed (or respectively pressed) configuration. The former configuration may have less sound attenuating properties, and the latter configuration, in FIG. 1b, may have better sound attenuating properties. The panel material 201 may for instance be a cellular material with holes (tunnels) cut into it. When pulled in one direction the holes will stretch and this will allow more sound to pass through. The arrow with the indication “x” indicates that (amongst others) a movement, such as by pressing or pulling, in the x direction may lead to different dimensions of the cavities 212 and thereby in the attenuating properties of the panel 100.

The sound attenuating unit comprises sound attenuating material with controllable sound attenuating properties, but may also have wave guiding properties, thereby allowing to combine in the sound attenuating unit 200 both sound attenuating properties and optical properties (see also below).

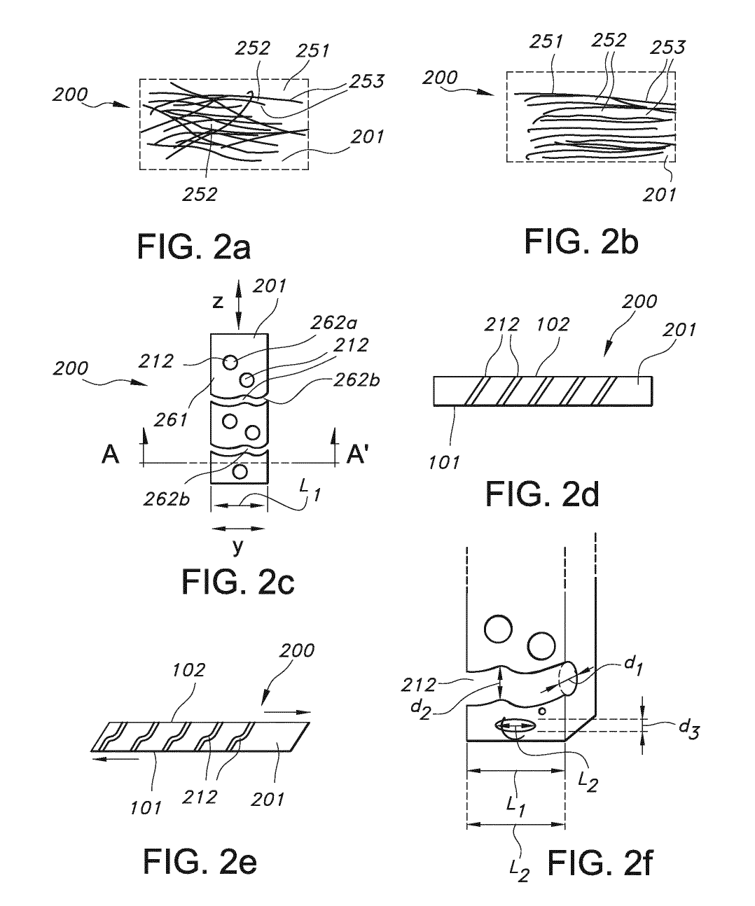

FIGS. 2a-2b schematically depicts a fibrous material and when pulled in one or more directions the space, indicated with references 252 between the fibers, indicated with references 253, increases and the sound absorption ability may be reduce. Here, the cavities 212 are the spaces 252 between the fibers 253.

FIG. 2c schematically depicts an embodiment with examples of cavities. The panel material 201 may comprises cavities 212 in the form of holes or spaces, which are also indicated with reference 262a. These cavities are no through cavities, with dimensions in general shorter than the width of the sound attenuating unit 200. The width of the unit is indicated with reference L1. Additionally or alternatively, the cavities 212 may also include pores or through holes, of which the lengths may be equal to the width L1 of the unit 200. Here, the panel material 201 is a porous material 261. Blind pores may also be present, but are not depicted in this schematic drawing. A cross-sectional view along line AA′ is shown in FIG. 2f. Actions to control sound attenuating properties may be by applying a force in the x (see also FIGS. 1a-1b), y and z direction, such as by pressure or by pulling, or twisting, or shearing, a combination of two or more of such actions, etc.

FIGS. 2d and 2e show another option, wherein use is made of a twisting/shear method for distorting the pores (along an axis). This may enable the sound absorbing material to switch from having tunnel pores, useful for when having a conversation, to blind pores which will block the sound more effectively when wanting to concentrate. The arrows indicate the twisting or shear direction that may for instance be possible. Other options may of course also be possible. References 101 and 102 indicate a first face and a second face of the panel 200, respectively.

FIG. 2f schematically depicts a cross-sectional view along line AA′ in FIG. 2c, to which also some 3D aspect is added. Here dimensions of cavities 212 are indicated, such as diameter d1 or widths and height, indicated with d2 and d3, respectively, and the length 12. Any change of one or more of those dimensions may lead to different acoustic properties, and thus different sound attenuating properties.

Referring to FIGS. 1a-2f, especially 1a-1b and 2a-2b these schematically show sound attenuating units 200 comprises a material with cavities 212 that are variable in one or more of width and diameter (see also FIG. 2f) Hence, an the infrastructure may be applied that is configured to controlling the one or more of width and diameter of the cavities in the sound attenuating unit.

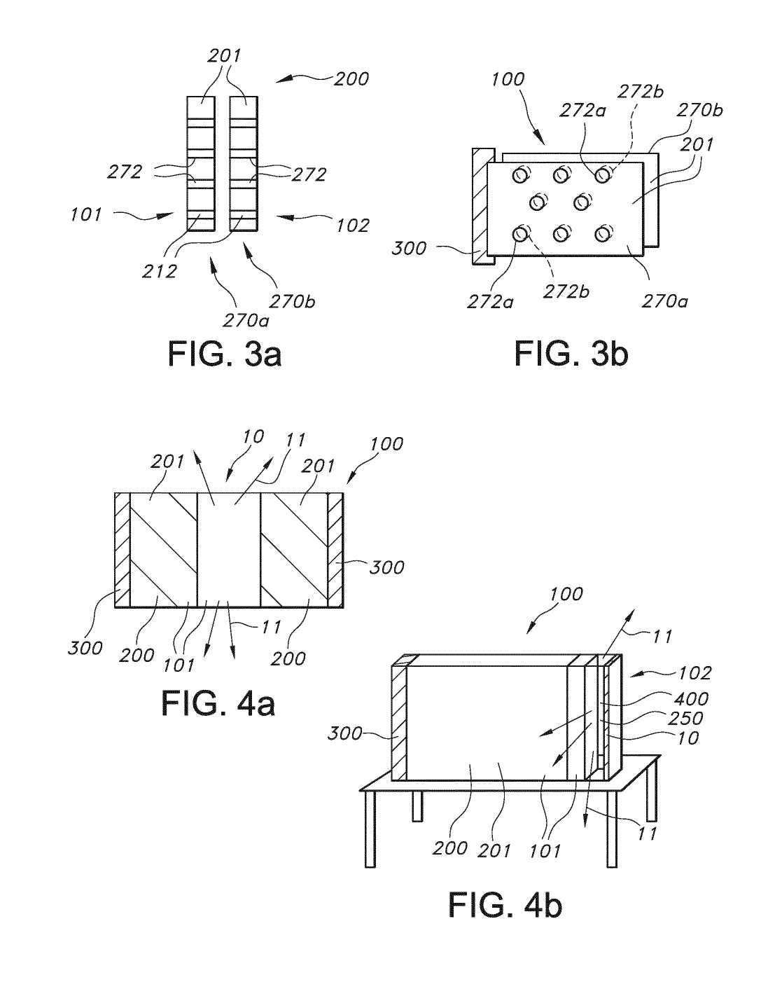

Additionally or alternatively, a surface with holes in it could slide over an identical or similar surface to open or close the holes. This is schematically shown in FIGS. 3a-3b wherein the sound attenuating unit 200 comprises two or more panels, here by way of example two panels 270a and 270b, arranged parallel and adjacent to each other, each panel 270a,270b comprising holes 272, wherein the two (or more) panels 270a,270b are arrangeable in a set of configurations comprising at least a first configuration and a second configuration with different sound attenuations. In FIG. 3a, the panels 270a,270b are arranged such that the holes overlap and in FIG. 3b the holes partly overlap. This latter configuration may lead to sound attenuation. Note that it is not necessary that the two or more panels 270a,270b are identical in the number, dimensions and arrangement of holes.

As indicated above, acoustic properties and lighting functionalities can both be included in the sound attenuating panel as described herein. The simplest embodiment is to have a window area for the light dividing element and the rest can be the active sound absorbing material. This material can be stretched or compressed by actuators or pulleys (e.g.) to open the pores or close them depending on the desired acoustic function. For example, if people want a setting for concentrated work, the lights will switch on to create visual privacy and the pores will open to absorb sound.

FIGS. 4a-4b schematically depict several embodiments. In FIG. 4a, the panel 100 comprises a light source 10, as well as the sound attenuating unit 200, which by way of example consists of two parts, arranged by way of example at both faces of the light source 10. The light source 10 may generate light source light 11. FIG. 4b schematically depicts an embodiment of the panel 100 which further comprises a transparent unit part 400. This transparent unit part 400 comprises transparent material 250. As schematically depicted, a spectator can see through the panel. The panel 100 also comprises a light source 10, which is configured to couple light source light 11 into the transparent unit 400. Thereby, light source light 11 can escape to one or both faces 101/102 of the panel, dependent upon how the transparent unit is configured. Especially, the transparent unit 400 is configured to couple light source light 11 out to both faces of the panel. Hence, FIG. 4b schematically depicts an embodiment of the sound attenuating panel 100, wherein the sound attenuating panel 100 comprises light source 10 that is configured to provide light 11 into the transparent unit part 400, wherein the transparent unit part 400 has light guiding properties and wherein the transparent unit part 400 is configured to allow transmission of visible light from a first face 101 of the sound attenuating panel 100 to a second face 102 (and here also vice versa), and wherein the transparent unit part 400 and light source 10 are configured to be able to provide light 12 escaping to at least one of the faces 101,102 of the sound attenuating panel 100.

Note that in the schematic drawing of FIG. 4b the transparent unit part 400 and the sound attenuating unit 200 are depicted as separate units, wherein the panel material of the sound attenuating unit 200 may especially comprise (controllable) attenuating properties and the material of the transparent unit 400, the transparent material 250, may (thus) especially comprise light transmissive properties. However, this single material may have both properties thereby allowing to combine in the sound attenuating unit 200 both sound attenuating properties and optical properties. Hence, in embodiments schematically depicted in the drawings, the panel material may comprise or consist of the transparent material 250.

Some sound absorbing materials are transparent or semi-transparent and it may be possible to conduct light through them. Alternatively, a (normal) surface with holes in it could slide over an identical or similar surface to open or close the holes (see also FIGS. 3a-3b). When the light is on, the holes will be misaligned and little noise will pass through the divider. When the light is off, the holes will align enabling an easier passage for the sound from one face to the next. Since the light can be dimmed, it is therefore possible to ‘dim’ the level of sound absorption depending on how open or closed the pores are set.

Alternatively, a structure could be made from a mesh of polymer with reactive polymers on the inside jointing them together. When a current is placed over the reactive polymer they can contract thus pulling parts of the two walls closer together in places to form deeper pores in which the sound can become trapped, thus increasing the sound absorbance level Light can be coupled in the faces or bottom of such a material and if the inside of the material is semi reflective, light can be trapped inside, thus increasing the degree of opacity.

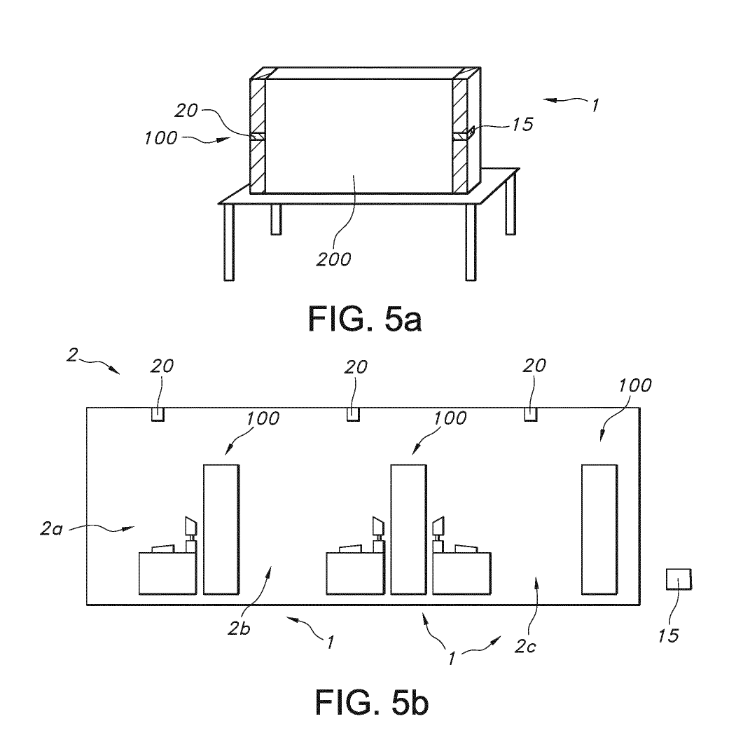

FIG. 5a schematically depicts an embodiment wherein the sound attenuating panel 100 further comprises a sensor 20 and a control unit 15. For instance, the control unit 15 may be configured to control a device as function of a sensor signal of the sensor 20, wherein the device is selected from the group consisting of the sound attenuating unit 200, the light source (not depicted, but see elsewhere) and another device (not depicted, but one may consider e.g. (other) lighting in a room where the panel 100 is present, an audio device, a video device, etc.). For instance, the sensor 20 may comprises one or more of a microphone and a sound pressure sensor. Note that the control unit 15 may be configured to be (further) controlled by another electronic device, like a computer, laptop, Smartphone, etc.

FIG. 5b schematcially depicts a system 1 comprising the sound attenuating panel 100 as described herein, a control unit 15, and a sensor 20. The control unit 15 may be configured to control a device as function of a sensor signal from the sensor, wherein the device is selected from the group consisting of the sound attenuating panel 100 and another device, such as the further lighting in a space 2, wherein the panel(s) 100 are arranged. Optionally, the control unit may be configured to control one or more of the sound attenuating panels 100 and other device locally. Hence, in such way e.g. sound and or light can be controlled locally, such as indicated with subspaces 2a,2b,2c (which may e.g. be cubicles). For instance, the sensor 200 comprises a sound sensor configured to measure sound in a space wherein the sound attenuating panel 100 is applied, configured to provide a corresponding sound sensor signal, wherein the sound attenuation properties of the sound attenuating panel 100 and optionally properties of the optional other device are controlled as function of the sound sensor signal.

1. A sound attenuating panel with controllable sound attenuation properties and controllable light transparency, the sound attenuating panel comprising
(a) a sound attenuating unit with cavities with variable dimensions,
(b) a transparent material,
(c) an actuator for controlling the dimensions of the cavities in the sound attenuating unit, and a light source for controlling the transparency of the sound attenuating panel.

2. The sound attenuating panel according to claim 1, wherein the sound attenuating unit comprises a material with cavities that are variable in one or more of width and diameter, and wherein the infrastructure is configured to controlling the one or more of width and diameter of the cavities in the sound attenuating unit.

3. The sound attenuating panel according to claim 1, wherein the sound attenuating unit comprises a fibrous material with spaces between adjacent fibers, and wherein the infrastructure comprises a device for applying a force to at least part of the sound attenuating unit.

4. The sound attenuating panel according to claim 1, wherein the sound attenuating unit comprises a deformable porous material with pores, and wherein the deformable porous material comprises a stimuli-responsive polymer.

5. The sound attenuating panel according to claim 1, wherein the sound attenuating unit comprises two or more panels, arranged parallel and adjacent to each other, each panel comprising holes, wherein the two or more panels, are arrangeable in a set of configurations comprising at least a first configuration and a second configuration with different sound attenuations.

6. The sound attenuating panel according claim 1, wherein the sound attenuating unit comprises a transparent unit part comprising a material that is transparent for visible light.

7. The sound attenuating panel according to claim 6, wherein the light source is configured to provide light into the transparent unit part, wherein the transparent unit part has light guiding properties and wherein the transparent unit part is configured to allow transmission of visible light from a first face of the sound attenuating panel to a second face and wherein the transparent unit part and light source are configured to be able to provide light escaping to at least one of the faces of the sound attenuating panel.

8. The sound attenuating panel according to claim 6, wherein the transparent unit part and light source are configured to be able to provide light escaping to both faces of the sound attenuating panel.

9. The sound attenuating panel according claim 6, wherein the sound attenuating unit comprises the material that is transparent for visible light.

10. The sound attenuating panel according to claim 1, further comprising a sensor and a control unit.

11. The sound attenuating panel according to claim 10, wherein the control unit is configured to control a device as function of a sensor signal of the sensor, wherein the device is selected from the group consisting of the sound attenuating unit, a light source and another device.

12. The sound attenuating panel according to claim 11, wherein the sensor comprises one or more of a microphone and a sound pressure sensor.

13. A system comprising the sound attenuating panel according to claim 1, a control unit and a sensor wherein the control unit is configured to control a device as function of a sensor signal from the sensor, wherein the device is selected from the group consisting of the sound attenuating panel and another device.

14. The system according to claim 13, wherein the sensor comprises a sound sensor configured to measure sound in a space wherein the sound attenuating panel is applied, configured to provide a corresponding sound sensor signal, wherein the sound attenuation properties of the sound attenuating panel and optionally properties of the optional other device are controlled as function of the sound sensor signal.

15. The sound attenuating panel according to claim 1, wherein the sound attenuating panel further comprises
a transparent unit part comprising a material that is transparent for visible light, wherein the transparent unit part is in a first state configured to allow transmission of visible light from one or more of (i) a first face to a second face, (ii) the second face to the first face, and (iii) both from the first face to the second face and from the second face to the first face of the sound attenuating panel, wherein (a) acoustic properties are controllable via the actuator for improving acoustics in a space, and (b) one or more of (b) the transmission of visible light through the transparent unit part and (b2) a perceived transmission through the transparent unit part is controllable via the light source providing light into the transparent unit part for controlling visual privacy in said space.
